(19) United States
(12) Patent Application Publication
(10) Pub. No.: US 2026/0023984 A1
(43) Pub. Date: Jan. 22, 2026

(54) ARTIFICIAL INTELLIGENCE USING CONFIGURATION-BASED LARGE LANGUAGE MODEL TASK DETERMINATION

(71) Applicant: Wells Fargo Bank, N.A., San Francisco, CA (US)

(72) Inventors: Jashua thejas Arul dhas, Charlotte, NC (US); Krishnakumar Chellappa, Indian Land, SC (US); Amrith Kumar, Charlotte, NC (US); Chintan Mehta, San Ramon, CA (US); Harish Mohan, Bangalore (IN); Swarup Pogalur, San Ramon, CA (US); Bindu Priya, Hyderabad (IN); Murali Ravipudi, Nanakramguda (IN); Suresh Reddy, Hyderabad (IN); Venkata Subbaiah g, Hyderabad (IN); Venkatesh Vengaldas, Hyderabad (IN); Suhas Yelluru, Fremont, CA (US)

(21) Appl. No.: 18/775,898

(22) Filed: Jul. 17, 2024

(51) Int. Cl. G06N 3/0985; G06N 3/091

(52) U.S. Cl. CPC G06N 3/0985; G06N 3/091

(57) ABSTRACT

An example computer system for selecting artificial intelligence can include: one or more processors; and non-transitory computer-readable storage media encoding instructions which, when executed by the one or more processors, causes the computer system to: receive a request from a requester for a task to be performed by a plurality of large language models; authenticate the requester; authorize the task based upon a type of the task and access for the requester to the plurality of large language models; select one of the plurality of large language models based upon the requester, the task, the type of task, and a payload associated with the task; transform the request to a transformed request based upon the one of the plurality of large language models; and forward the transformed request to the one of the plurality of large language models to perform the task.

### BACKGROUND

Generative Artificial Intelligence (GenAI) has demonstrated its applicability across diverse industries. Its user-friendly nature makes GenAI likely to become widely used in various domains. However, developers face significant challenges in establishing a resilient infrastructure that can seamlessly operate across different cloud architectures, including single cloud, hybrid cloud, and multi-cloud setups. This complexity poses a hurdle for developers creating applications that harness GenAI.

### SUMMARY

Examples provided herein are directed to providing Artificial Intelligence using configuration-based endpoint determination.

According to one aspect, an example computer system for selecting artificial intelligence can include: one or more processors; and non-transitory computer-readable storage media encoding instructions which, when executed by the one or more processors, causes the computer system to: receive a request from a requester for a task to be performed by a plurality of large language models; authenticate the requester; authorize the task based upon a type of the task and access for the requester to the plurality of large language models; select one of the plurality of large language models based upon the requester, the task, the type of task, and a payload associated with the task; transform the request to a transformed request based upon the one of the plurality of large language models; and forward the transformed request to the one of the plurality of large language models to perform the task.

According to another aspect, an example method for selecting artificial intelligence can include: receiving a request from a requester for a task to be performed by a plurality of large language models; authenticating the requester; authorizing the task based upon a type of the task and access for the requester to the plurality of large language models; selecting one of the plurality of large language models based upon the requester, the task, the type of task, and a payload associated with the task; transforming the request to a transformed request based upon the one of the plurality of large language models; and forwarding the transformed request to the one of the plurality of large language models to perform the task.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example system for providing Artificial Intelligence using configuration-based endpoint determination.

FIG. 2 shows example logical components of a server device of the system of FIG. 1.

FIG. 3 shows additional example details of the server device of FIG. 2.

FIG. 4 shows example physical components of the server device of FIG. 2.

### DETAILED DESCRIPTION

This disclosure relates to providing Artificial Intelligence (AI) using configuration-based endpoint determination.

Through the concepts provided herein, users can submit a standard input contract for execution by GenAI, typically a Large Language Model (LLM). This standard input contract can include various tasks, such as:
search-search indexed documents;
ingest-index documents in a vector store;
generate-perform text generation;
classify-classify text; and
summarize-perform text summarization.

Requesters can submit these task-specific standard input contracts, which minimize the time-consuming process of understanding various proprietary architectures, cloud platforms, and models. Through these concepts, requesters can achieve various stages of model and services application through a single request/channel. Example features of the disclosed concepts can include one or more of: (i) a standard input contract; (ii) an LLM Inferencing layer rate limit and user level usage rate limit; (iii) seamless switch and interoperability between various platforms (on-premises and cloud); (iv) user-level governance and control; (v) LLM Inferencing layer ethical integration; and/or (vi) user feedback mechanism.

These considerations can be used to provide a configuration-based endpoint determination for the selection of the endpoint GenAI. In the examples provided herein, these configurations used to make the endpoint selection can be based upon one or more of the following aspects.

Endpoint determination=[authentication]+[authorization]+[contract terms]

Other options aspects can include ethics, safety, and feedback. Various aspects of the concepts provided herein result in advantages over the current technology. For instance, the concepts can provide for access control. This means that, as users are onboarded to the platform, user actions are limited based on roles and privileges. Further, the concepts provide various improvement in governance.

The concept provides the practical application of a standard input contract that follows a standard template, which contains use case specific key and context details. This standard input contract can be validated for correctness. Further, the standard input contract is used to generate use case-specific platform and model requests that can be governed for compliance and control considerations. Further, the concepts allow for implementation of ethics and compliance considerations, as described further below.

Various other controls can also be implemented, such as rate limits and content moderation. Safety can also be addressed, and user feedback can be provided for future reinforcement learning efforts for custom-trained models.

Multiple aspects of the disclosed concepts can result in practical applications of the technology. For instance, the standard input contract can provide the practical application of a unified payload structure that is more easily defined by a classification identifier that defines the platform, task and model. This can further be scaled to accommodate additional features and controls. This allows for reduced development effort for users, as the concepts provide the capability to perform the requested tasks based on the input provided using various platforms and models. This has the practical application of allowing the concept to leverage various providers, both on-premises and in-cloud, with a single use case.

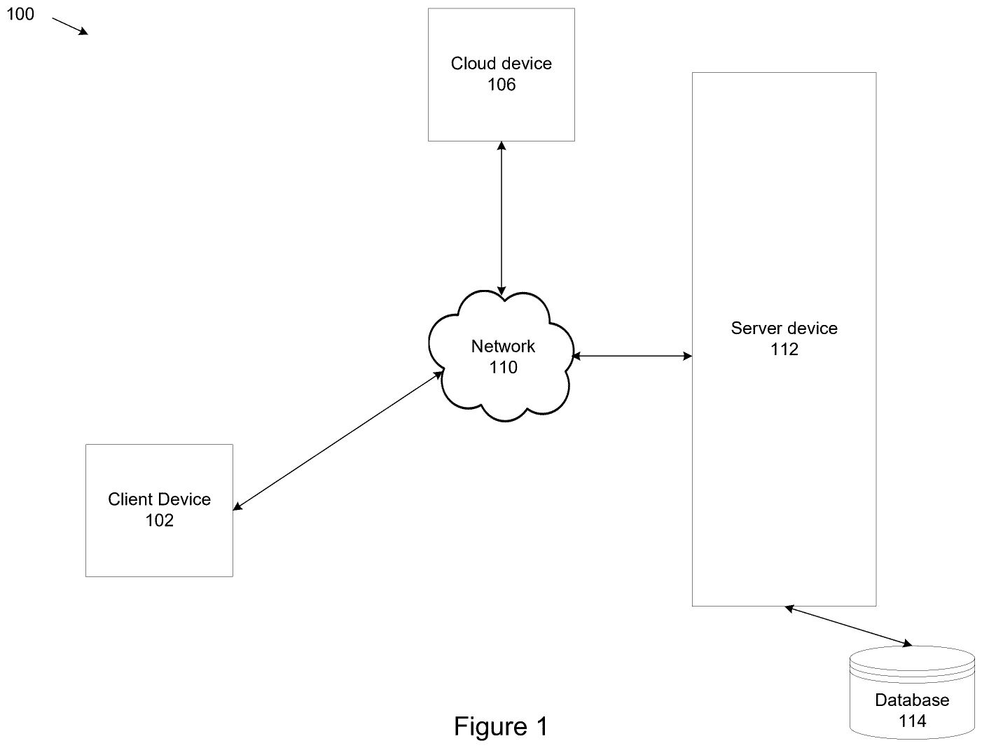

FIG. 1 schematically shows aspects of one example system 100 programmed to provide various tasks performed by an LLM, such as search, ingest, generate, summarize, and/or classify. In this example, the system 100 can be a computing environment that includes a plurality of client and server devices. In this instance, the system 100 includes a client device 102, a cloud device 106, a server device 112, and a database 114. The client device 102 and the cloud device 106 can communicate with the server device 112 through a network 110 to accomplish the functionality described herein.

Each of the devices may be implemented as one or more computing devices with at least one processor and memory. Example computing devices include a mobile computer, a desktop computer, a server computer, or other computing device or devices such as a server farm or cloud computing used to generate or receive data.

In some non-limiting examples, the server device 112 is owned by a financial institution, such as a bank. The client device 102 and the cloud device 106 can be programmed to communicate with the server device 112 to provide access to the tasks performed by a LLM hosted by the server device 112 and/or the cloud device 106. Many other configurations are possible.

The example client device 102 is programmed to access LLM functionality as provided by the server device 112 and/or the cloud device 106. For instance, the client device 102 can access either the server device 112 and/or the cloud device 106 to request such tasks as searching for documents, ingesting documents, generating content and documents, summarizing content, etc. Specific examples of such tasks are described below.

The example cloud device 106 is programmed to provide the functionality associated with an LLM. This can include, without limitation, such tasks as search, ingest, generate, summarize, and/or classify. Examples of such cloud providers include, without limitation, the Google Cloud Platform and Microsoft Azure.

The example server device 112 is programmed to provide GenAI functionality using configuration-based endpoint determination. More specifically, the server device 112 receives requests for tasks from the client device 102. This can include, without limitation, such tasks as search, ingest, generate, summarize, and/or classify. The server device 112 is programmed to take a standard request, determine which LLM should perform the task, and formulate that request to access tasks to be performed by the relevant LLM, on-premises and/or hosted by the cloud device 106.

More specifically, the server device 112 hosts an LLM on premises, such as by the database 114. Similarly, the cloud device 106 hosts one or more LLMs in the cloud. The client device 102 can make standard request to the server device 112 for one or more tasks to be performed by an LLM. The server device 112 can, in turn, receive that request and determine which LLM should perform the task. The LLM can be hosted on the server device 112 (on-premises) and/or on the cloud device 106 (cloud). Once the LLM is selected, the server device 112 communicate with that LLM through one or more Application Programming Interfaces (APIs). These APIs can provide an agnostic approach to accessing the LLMs, which removes any tight binding to a particular platform. It can further allow for switching between LLMs while accessing proprietary functionality through a common interface.

The example database 114 is programmed to store data accessible by the server device 112. Such data can include an on-premises LLM metadata hosted by the server device 112. The data can also include the rules needed to convert a standard input contract from the client device 102 into a specific input contract for consumption by either the on-premises or cloud LLM.

For instance, in one embodiment, the database 114 is split into multiple databases. One database can house details associated with the look-ups for the configuration-based selection of the LLMs, and another database can house models associated with the LLMs. Other embodiments and additional details are provided below.

The network 110 provides a wired and/or wireless connection between the client device 102, the cloud device 106, and the server device 112. In some examples, the network 110 can be a local area network, a wide area network, the Internet, or a mixture thereof. Many different communication protocols can be used. Although only three devices are shown, the system 100 can accommodate hundreds, thousands, or more of computing devices.

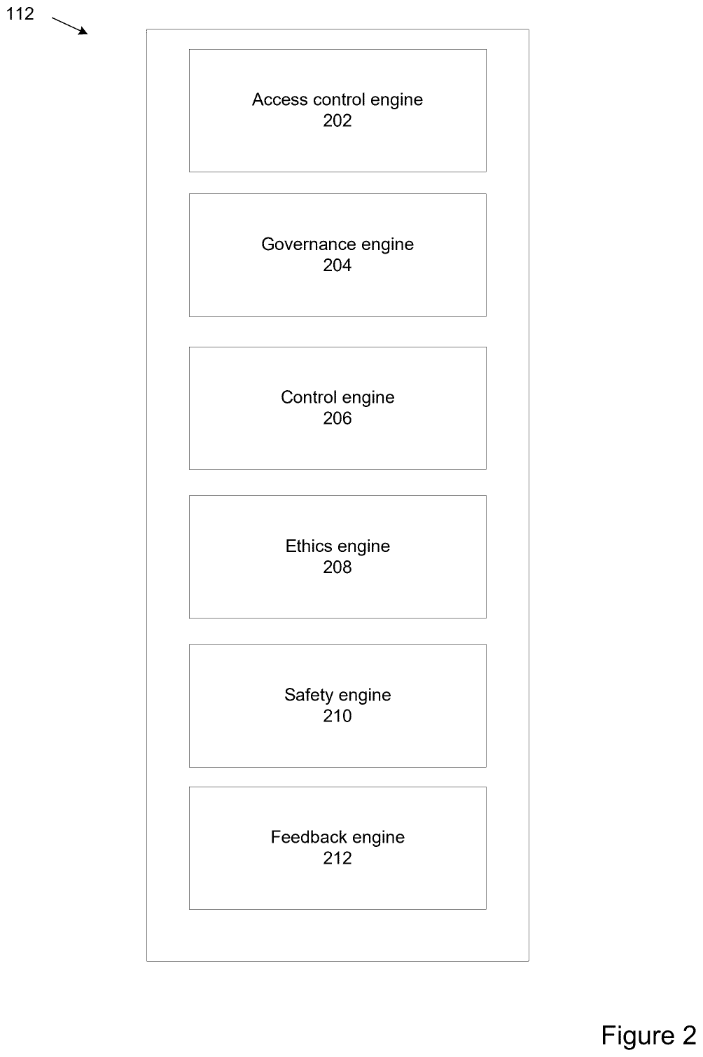

Referring now to FIG. 2, additional details of the server device 112 are shown. In this example, the server device 112 has various logical engines that assist in providing GenAI functionality using configuration-based endpoint determination.

In these examples, the server device 112 is programmed to direct such requests across various platforms, including both on-premises and cloud-based. The server device 112 accepts a standard input through the API, which cases in switching between models and data sets across these platforms.

More specifically, the server device 112 is programmed to standardize the contracts provided by the client device 102 to request tasks for the various LLMs. As noted, this minimizes the tightly bound resources per platform, since one request from the client device 102 can be used to initiate tasks on all platforms. Further, the server device 112 can standardize the governance of such requests and task. The server device 112 can further be programmed to control expenses and rates associated with such requests and tasks.

The server device 112 can, in this instance, include an access control engine 202, a governance engine 204, a control engine 206, an ethics engine 208, a safety engine 210, and a feedback engine 212. In other examples, more or fewer engines providing different functionality can be used.

The example access control engine 202 is programmed to limit users that are onboarded to the system 100. This is done by allowing the access control engine 202 to define roles and privileges for certain actions that are done on the system 100. For instance, one user may be given permissions to access tasks on an LLM on-premises, while another user may be given permission to access an LLM on a cloud provider. There can be additional roles which determine the user privileges to perform certain actions (e.g., super user, end user, governance user, etc.).

Further, the access control engine 202 can define data classifications that allow the users more flexibility of storing data. This can include allowing data to be stored on-premises (e.g., database 114) and in the cloud (e.g., cloud device 106) in certain instances.

The example governance engine 204 is programmed to manage governance considerations for the user of LLMs. This can include leveraging a model for governance that is continuously assessed. The model is proactively monitored for accuracy as requests are made to the LLMs.

The example control engine 206 is programmed to accept standard input contracts from the client device 102 and automatically generate tasks for the relevant LLM(s). The standard input contract provides the case and context that are necessary to request the task and receive the resulting output.

More specifically, the control engine 206 is programmed to take the standard input contract from the client device 102 and determine which LLM is appropriate to perform the task(s) in the standard input contract based upon the case and context associated therewith. In some examples, the standard input contract can include at least the following.

| Requester identifier | Payload |
|---|---|
| 123456 | search; terms: realize, deposit |

In this example, the standard input contract includes: (i) a requester identifier (“123456”) that identifies the requester; and (ii) a payload (“search; terms: realize, deposit”) that defines the contract including the tasks requested.

In such an example, the control engine 206 verifies the requester identifier to determine whether the requester has the proper authorizations to make the request. In one instance, the requester identifier indicates the source of the request, such as the application making the request. Such applications can be communication platforms (e.g., Microsoft Teams), browsers (e.g., Google Chrome, Microsoft Edge), etc. The requester identifier can also identify the user making the request.

Once authentication and authorization are performed, the control engine 206 is programmed to verify the payload, which is the portion of the standard input contract that defines the task(s) that are requested by the requester. The payload can be defined in a standard nomenclature that defines the task(s) request. For instance, the request may be to search for particular terms. The request may or may not define a particular LLM to perform the task.

The control engine 206 uses a configuration-based approach to determine that the requester has the authorization to perform the specified task(s) within the requested LLM (if defined). For instance, each requester identifier can be stored in a registry of the database 114 along with the tasks for which the requester identifier is authorized. For instance, a specific requester, such as a particular application or user, may be authorized to perform a search task but not an ingestion task. The authorization can also be specific to the type of LLM. For instance, the requester may be authorized to search some LLMs while not others. The control engine 206 can make such determinations and either allow or disallow the request based upon the authorizations.

For instance, assume the request above where a search task is requested for particular search terms. Since an LLM is not defined, the control engine 206 again uses a configuration-based approach to identify one or more LLMs that can be the target of the search. This can be done based upon the identity of the requester, the type of request made, etc. Once the LLMs are identified, the control engine 206 queries the database 114 to determine whether the requester has the necessary authorization to perform the requested task(s) on the identified LLMs. If not, the control engine 206 returns an error message and disallows the request.

If the requester does have the necessary authorization, then the control engine 206 is programmed to transform the standard input contract into a format that is consumable by the relevant LLMs. This can include transforming both the task and/or the information associated with the task. For instance, the selected LLM may use different nomenclature to request a search task.

Once transformed, the control engine 206 forwards the transformed request to the relevant LLMs through the APIs provided by the LLMs. Additional details are provided below. Once the task is complete, the LLMs can route the results directly back to the client device 102. Or, in the case where multiple LLMs are needed to perform a request, the result can be routed by the first LLM back to the server device 112. The server device 112 can thereupon perform the necessary authentication, authorization, and transformation to provide the output from the first LLM to the second LLM for further processing of task(s). Additional details are provided below.

The example ethics engine 208 is programmed to verify that the standard input contract from the client device 102 is in conformance with rules, regulations, and legal constructs set by an organization and regulatory bodies. There can be transparent auditing and monitoring for such undesirable aspects, as hallucination and toxicity/bias. For instance, output generation can be monitored through ethical values (eliminating bias, harmful, misleading contents, etc.). Other configurations are possible.

The example safety engine 210 is programmed to perform such actions as simulation analysis, domain testing, and real-time monitoring. For example, the safety engine 210 can be programmed to perform simulation analysis by modeling and mimicking real-world scenarios or systems, allowing for the evaluation of various variables and their impact on the desired outcomes. This can help in predicting and understanding the behavior, performance, and effectiveness of the system 100 before its actual implementation. The safety engine 210 can also perform domain testing by selecting test cases to ensure that all possible inputs within a specific domain or range are tested for their behavior and expected outcomes. Finally, the safety engine 210 can perform real-time monitoring by continuously and actively collecting and analyzing such data from the system 100 in order to promptly detect and respond to any issues or anomalies in its performance.

The example feedback engine 212 is programmed to accept feedback from the requester to determine an accuracy, quality, and utility of the results of the tasks. For instance, once the results of the request are provided to the client device 102, the client device 102 can be programmed to accept feedback from the requester as to the accuracy of the results. This feedback can be used to further train the system 100.

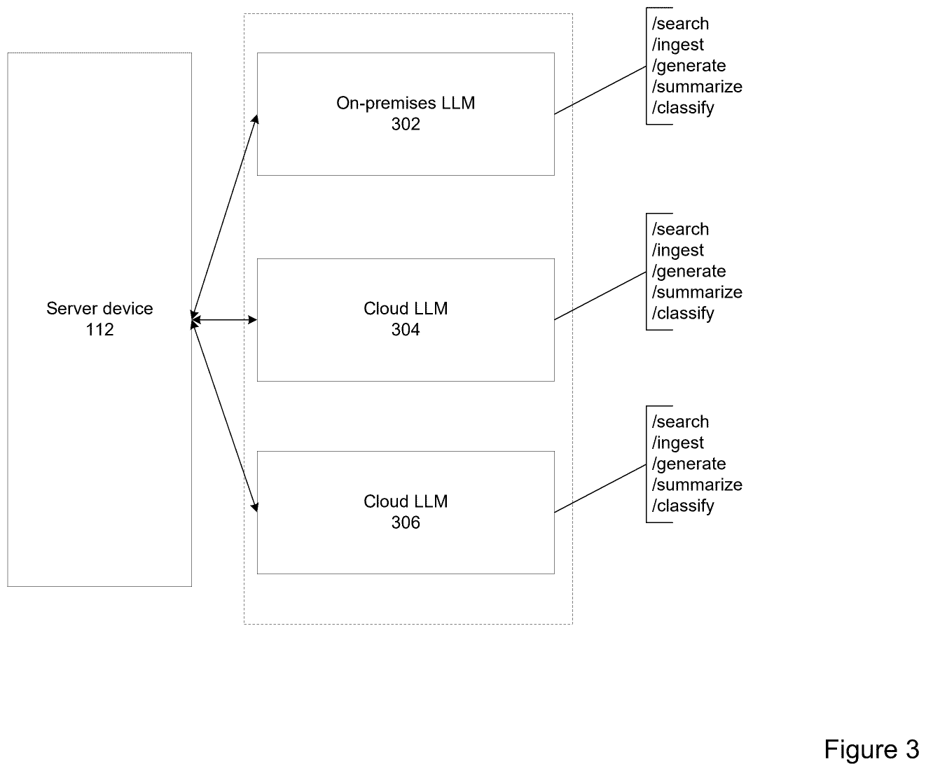

FIG. 3 illustrates additional details regarding the functionality of the server device 112. In this example, the server device 112 is shown communicating with various LLMs through APIs. In this example, the server device 112 communicates with an on-premises LLM 302 that is hosted by the server device 112. The server device 112 also communicates with third party LLMs hosted in cloud environment, including a cloud LLM 304 and a cloud LLM 306. Each of the LLMs can perform various tasks, such as search, ingest, generate, summarize, and/or classify.

Continuing the example above, assume the requester has provided a request for a “search” for terms “realize, deposit”, which would indicate to the request how long it will take until a deposit of a check is realized and otherwise available in an account.

The control engine 206 determines which LLM to route the request. Since the request relates to realization of a deposit, the control engine 206 can route the request to the on-premises LLM 302 to answer the request. Before doing so, the control engine 206 determines if the requester is authorized by querying the database 114 to access the example registry below to determine authorization.

| Requester identifier | LLM | Action | Allowed? |
|---|---|---|---|
| 123456 | LLM 302 | search | Y |
| 123456 | LLM 302 | ingest | N |
| 123456 | LLM 302 | generate | N |
| 123456 | LLM 302 | summarize | N |
| 123456 | LLM 302 | classify | N |

The registry indicates that the requester 123456 is authorized to perform a search task on the LLM 302. Given that, the control engine 206 will transform the request into the nomenclature accepted by the on-premises LLM 302 and transmit the request to the API associated with the on-premises LLM 302. Many other configurations are possible.

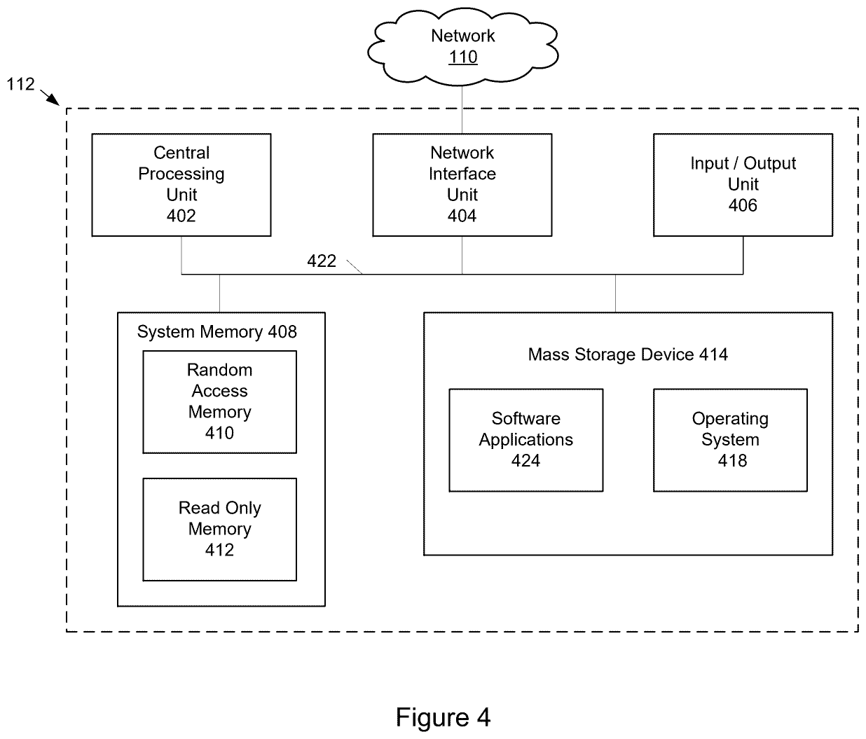

As illustrated in the embodiment of FIG. 4, the example server device 112, which provides the functionality described herein, can include at least one central processing unit (“CPU”) 402, a system memory 408, and a system bus 422 that couples the system memory 408 to the CPU 402. The system memory 408 includes a random access memory (“RAM”) 410 and a read-only memory (“ROM”) 412. A basic input/output system containing the basic routines that help transfer information between elements within the server device 112, such as during startup, is stored in the ROM 412. The server device 112 further includes a mass storage device 414. The mass storage device 414 can store software instructions and data. A central processing unit, system memory, and mass storage device similar to that shown can also be included in the other computing devices disclosed herein.

The mass storage device 414 is connected to the CPU 402 through a mass storage controller (not shown) connected to the system bus 422. The mass storage device 414 and its associated computer-readable data storage media provide non-volatile, non-transitory storage for the server device 112. Although the description of computer-readable data storage media contained herein refers to a mass storage device, such as a hard disk or solid-state disk, it should be appreciated by those skilled in the art that computer-readable data storage media can be any available non-transitory, physical device, or article of manufacture from which the central display station can read data and/or instructions.

Computer-readable data storage media include volatile and non-volatile, removable, and non-removable media implemented in any method or technology for storage of information such as computer-readable software instructions, data structures, program modules, or other data. Example types of computer-readable data storage media include, but are not limited to, RAM, ROM, EPROM, EEPROM, flash memory or other solid-state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the server device 112.

According to various embodiments of the invention, the server device 112 may operate in a networked environment using logical connections to remote network devices through network 110, such as a wireless network, the Internet, or another type of network. The server device 112 may connect to network 110 through a network interface unit 404 connected to the system bus 422. It should be appreciated that the network interface unit 404 may also be utilized to connect to other types of networks and remote computing systems. The server device 112 also includes an input/output controller 406 for receiving and processing input from a number of other devices, including a touch user interface display screen or another type of input device. Similarly, the input/output controller 406 may provide output to a touch user interface display screen or other output devices.

As mentioned briefly above, the mass storage device 414 and the RAM 410 of the server device 112 can store software instructions and data. The software instructions include an operating system 418 suitable for controlling the operation of the server device 112. The mass storage device 414 and/or the RAM 410 also store software instructions and applications 424, that when executed by the CPU 402, cause the server device 112 to provide the functionality of the server device 112 discussed in this document.

Although various embodiments are described herein, those of ordinary skill in the art will understand that many modifications may be made thereto within the scope of the present disclosure. Accordingly, it is not intended that the scope of the disclosure in any way be limited by the examples provided.

What is claimed is:

1. A computer system for selecting artificial intelligence, comprising:
one or more processors; and
non-transitory computer-readable storage media encoding instructions which, when executed by the one or more processors, causes the computer system to:
receive a request from a requester for a task to be performed by a plurality of large language models;
authenticate the requester;
authorize the task based upon a type of the task and access for the requester to the plurality of large language models;
select one of the plurality of large language models based upon the requester, the task, the type of the task, and a payload associated with the task;
transform the request to a transformed request based upon the one of the plurality of large language models; and
forward the transformed request to the one of the plurality of large language models to perform the task.

2. The computer system of claim 1, wherein the task is received in a standard input contract.

3. The computer system of claim 2, wherein the standard input contract identifies the requester and transforms the payload with the task.

4. The computer system of claim 1, wherein, to authorize the task, the computer system comprises further instructions which, when executed by the one or more processors, causes the computer system to determine authorization based upon a requester identifier associated with the requester, the type of the task, and the one of the plurality of large language models.

5. The computer system of claim 4, comprising further instructions which, when executed by the one or more processors, causes the computer system to query a registry with the requester identifier associated with the requester, the type of the task, and the one of the plurality of large language models.

6. The computer system of claim 1, wherein, to forward the transformed request, the computer system comprises further instructions which, when executed by the one or more processors, causes the computer system to send the task to an application programming interface associated with the one of the plurality of large language models.

7. The computer system of claim 1, comprising further instructions which, when executed by the one or more processors, causes the computer system to verify conformance with regulations associated with the task.

8. The computer system of claim 1, comprising further instructions which, when executed by the one or more processors, causes the computer system to perform safety actions including simulation analysis, domain testing, and real-time monitoring.

9. The computer system of claim 1, comprising further instructions which, when executed by the one or more processors, causes the computer system to receive feedback from the requester regarding an accuracy of a result of the task from the one of the plurality of large language models to perform the task.

10. The computer system of claim 1, wherein the plurality of large language models include at least an on-premises large language model and a cloud-based large language model.

11. A method for selecting artificial intelligence, comprising:
receiving a request from a requester for a task to be performed by a plurality of large language models;
authenticating the requester;
authorizing the task based upon a type of the task and access for the requester to the plurality of large language models;
selecting one of the plurality of large language models based upon the requester, the task, the type of the task, and a payload associated with the task;
transforming the request to a transformed request based upon the one of the plurality of large language models; and
forwarding the transformed request to the one of the plurality of large language models to perform the task.

12. The method of claim 11, wherein the task is received in a standard input contract.

13. The method of claim 12, wherein the standard input contract identifies the requester and includes the payload with the task.

14. The method of claim 11, further comprising determining authorization based upon a requester identifier associated with the requester, the type of the task, and the one of the plurality of large language models.

15. The method of claim 14, further comprising querying a registry with the requester identifier associated with the requester, the type of the task, and the one of the plurality of large language models.

16. The method of claim 11, further comprising sending the task to an application programming interface associated with the one of the plurality of large language models.

17. The method of claim 11, further comprising verifying conformance with regulations associated with the task.

18. The method of claim 11, further comprising performing safety actions including simulation analysis, domain testing, and real-time monitoring.

19. The method of claim 11, further comprising receiving feedback from the requester regarding an accuracy of a result of the task from the one of the plurality of large language models to perform the task.

20. The method of claim 11, wherein the plurality of large language models include at least an on-premises large language model and a cloud-based large language model.
